(19) United States
(12) Patent Application Publication
(10) Pub. No.: US 2009/0109165 A1
(43) Pub. Date: Apr. 30, 2009

(54) DISPLAY DEVICE AND DRIVING METHOD THEREOF

(76) Inventors: Mun-Soo PARK, Suwon-si (KR); Yun-Jae Park, Yongin-si (KR); Myeong-Su Kim, Cheonan-si (KR); Kyung-Uk Choi, Asan-si (KR)

Correspondence Address: Haynes and Boone, LLP;IP Section, 2323 Victory Avenue, SUITE 700, Dallas, TX, 75219, US

(21) Appl. No.: 12/128,537

(22) Filed: May 28, 2008

(30) Foreign Application Priority Data
Oct. 31, 2007 (KR) 10-2007-0110330

(51) Int. Cl. G02F 1/13357; G09G 3/36

(52) U.S. Cl. 345/102; 345/589

(57) ABSTRACT

A backlight unit for a display device that reduces power consumption while and display of undesirable artifacts in images is presented. The backlight unit is divided into a plurality of light-emitting regions, and a luminance control signal generator controls the luminance of light emitted by each of the light-emitting regions. The luminance of a particular light-emitting region is controlled by taking into account light interference from an adjacent light-emitting region. A display panel to display images through light emitted from the backlight unit, and a backlight driver drives the backlight unit.

### CROSS-REFERENCE TO RELATED APPLICATION

The present application claims priority from Korean Patent Application No. 2007-0110330 filed on Oct. 31, 2007, the disclosure of which is incorporated herein by reference in its entirety.

### BACKGROUND

1. Field of Invention

The present invention relates to a display device and a method of driving the display device. More particularly, the present invention relates to a display device that controls the luminance level of a backlight unit and a method of driving the display device.

2. Discussion of Related Technology

A liquid crystal display (“LCD”) device typically includes an LCD panel and a backlight unit that supplies light to the LCD panel.

An LCD panel typically includes gate lines, data lines, a thin film transistor (“TFT”) substrate on which TFTs and pixel electrodes are formed, and a color filter substrate on which color filters and common electrodes are formed. The LCD panel displays images by controlling the transmission of light from the backlight unit through the liquid crystal layer. The transmission of light through the liquid crystal layer is often controlled through pixel voltage.

In an LCD device made with the LCD panel, a backlight unit is often disposed on the rear surface of the LCD panel to provide light because the LCD panel does not emit light.

The backlight unit includes a fluorescence lamp or a light-emitting diode (“LED”). Recently, LED has come to be widely used as the backlight unit due to its low power consumption and excellent color presentation.

The backlight unit supplies the LCD panel with light having a uniform luminance regardless of a desirable image gray-scale. Accordingly, when the LCD panel displays a dark image, the contrast ratio becomes low due to light leakage.

The backlight unit may control a frame luminance by computing an average luminance of a pixel data signal corresponding to the frame. However, with this method, when there are a high luminance image and a low luminance image in the frame, the high luminance image cannot be displayed with the appropriate luminance level, thereby decreasing the overall luminance of the LCD device.

### SUMMARY

The present disclosure provides a display device capable of preventing formation of undesirable artifacts that are caused by a luminance difference between adjacent display regions.

The present disclosure also provides a method for manufacturing the display device.

A display device in accordance with one aspect of the present invention includes a backlight unit including a plurality of light-emitting regions, a display panel displaying images by using light emitted from the backlight unit, a backlight driver driving the backlight unit, and a luminance control signal generator controlling the luminance of the light-emitting regions. The light-emitting regions include a first light emitting region and a second light emitting region that is adjacent to the first light-emitting region. The luminance control signal generator controls the luminance of the first light-emitting region according to an amount of light interference between the first light-emitting region and the second light-emitting region.

The luminance control signal generator may include a luminance extractor to generate an luminance value of each of the light-emitting regions in response to pixel data signals, a luminance compensator to compute an interference value corresponding to the luminance value and to generate a compensation value, and a dimming calculator to generate a dimming signal corresponding to the compensation value and to supply the dimming signal to the backlight driver. The interference value indicates the amount of light interference.

The luminance control signal generator may compare the compensation value with a predetermined maximum luminance value corresponding to the maximum current level that is allowed for each of the light-emitting regions and may generate the dimming signal corresponding to the compensation value when the compensation value is less than the maximum luminance value. When the compensation value is equal to or greater than the maximum luminance value, the luminance control signal generator may generate a dimming signal corresponding to the predetermined maximum luminance value.

The backlight driver may further include a pulse width modulation (“PWM”) signal generator to generate PWM signals having duty ratio corresponding to the dimming signal and a light emitting diode (“LED”) driver to control an electric current according to the duty ratio of the PMW signals.

Where a plurality of backlight drivers are used, the same number of the backlight driver may be formed as the number of the light-emitting regions.

The backlight unit may include at least one LED in each of the light-emitting regions.

The backlight unit may further include a plurality of LEDs electrically connected to each other in series in each of the light-emitting regions.

The LEDs may include a white LED.

The backlight unit may further include a red LED, a green LED, and a blue LED in each of the light-emitting regions.

The backlight unit may include a plurality of red LEDs,a plurality of green LEDs, and a plurality of blue LEDs electrically connected in series to the same color LEDs and the backlight driver may drive the red LED, the green LED, and the blue LED in color groups, each color group having LEDs of the same color.

The display device may further include a light sensor to measure the luminance of the backlight unit, and a sensor signal modulator to modulate a light detect signal provided from the light sensor and to supply the light detect signal to the luminance control signal generator.

The interference value measuring light interference from an adjacent light-emitting region may be between about 5% to about 30% of the luminance value.

A method of driving a display device in accordance with another aspect of the present invention includes computing a luminance value of each of light-emitting regions in a backlight unit, computing a compensation value for each of the light-emitting regions, generating a dimming signal corresponding to the compensation value, and supplying light corresponding to the dimming signal to each of the light-emitting regions.

Computing of the compensation value may include adding the luminance value to the interference value, wherein the interference value indicates an amount of interference between light from adjacent display regions.

Generating of the dimming signals may further include comparing the compensation value with a predetermined maximum luminance value, generating the dimming signal corresponding to the predetermined maximum luminance value when the compensation value is equal to or greater than the predetermined maximum luminance value, and generating the dimming signal corresponding to the compensation value when the compensation value is less than the predetermined maximum luminance value.

Generating of the light may include generating a PWM signal having a duty ratio corresponding to the dimming signal and supplying an electric current corresponding to the duty ratio to each of the light-emitting regions.

Supplying of the electric current may include measuring the luminance corresponding to each of the light-emitting regions and comparing the measured luminance with the compensation value to control the luminance of the backlight unit.

It is to be understood that both the foregoing general description and the following detailed description are merely exemplary and explanatory and not intended to be unduly limiting.

### BRIEF DESCRIPTION OF THE DRAWINGS

The accompanying drawings are included to provide a further understanding of the disclosed embodiments and serve to better explain the principles of the disclosure. In the drawings:

FIG. 1 is schematic block diagram of an LCD device according to a first embodiment of the present invention;

FIG. 2 is a plan view schematically illustrating the backlight unit in FIG. 1 according to a second embodiment of the present invention;

FIG. 3 is a plan view schematically illustrating the backlight unit of FIG. 1 according to a third embodiment of the present invention;

FIG. 4 is a schematic block diagram illustrating the backlight driver in FIG. 1;

FIG. 5 is a schematic block diagram of the relationship of a backlight driver and the backlight unit in FIG. 1;

FIG. 6 is a schematic block diagram of the luminance control signal generator in FIG. 1;

FIG. 7 is a schematic graph presenting a luminance distribution of light emitted from the backlight unit;

FIG. 8 is a block diagram of a 5×5 point spread function (“PSF”) filter window;

FIG. 9 is a block diagram of a 3×5 PSF filter window;

FIG. 10 is a block diagram illustrating luminance values of a display region in the LCD panel;

FIG. 11 is a block diagram illustrating predetermined luminance values of a light-emitting region obtained by using a compensation value;

FIG. 12 is a plan view illustrating the effectiveness of the luminance control signal generator in the LCD device according to the first embodiment of the present invention;

FIG. 13 is a graph representing the luminance values of a display region obtained in FIG. 12;

FIG. 14 is a flow chart of a method of driving the LCD device according to the first embodiment of the present invention; and

FIG. 15 is a schematic block diagram of an LCD device according to a second embodiment of the present invention.

### DETAILED DESCRIPTION

Reference will now be made in detail to the exemplary embodiments of the present disclosure, examples of which are illustrated in the accompanying drawings. Wherever possible, the same reference numbers will be used throughout the drawings to refer to the same or like parts.

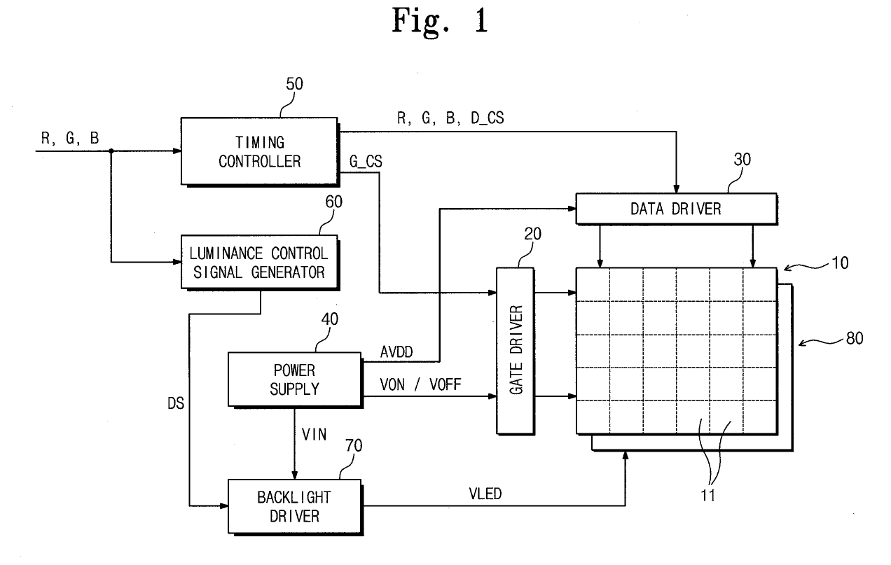

FIG. 1 is a schematic block diagram of an LCD device according to a first embodiment of the present invention.

The LCD device includes an LCD panel 10, a gate driver 20, a data driver 30, a power supply 40, a timing controller 50, a backlight unit 80, a backlight driver 70, and a luminance control signal generator 60.

The LCD panel 10 includes a plurality of gate lines, a plurality of data lines formed to extend perpendicularly to the gate lines, thin film transistors formed at intersections between the gate and data lines, and pixel electrodes connected to and driven by the thin film transistors. The LCD panel 10 receives a gate-on voltage VON from the gate lines and a data voltage from the data lines to display images.

The LCD panel 10 may include a plurality of display regions 11. The display regions 11 may correspond to light-emitting regions of the backlight unit 80. The display regions 11 may receive light from the light-emitting regions of the backlight unit 80 to form images having a different luminance according to a respective display region 11.

The gate driver 20 may sequentially supply the gate-on voltage VON and a gate-off voltage VOFF supplied from the power supply 40 to the gate lines formed on the LCD panel 10 in response to a gate control signal G_CS supplied from the timing controller 50.

The data driver 30 may output the data voltage in the form of a gray-scale voltage corresponding to data signals R, G and B supplied from the timing controller 50 in response to a data control signal D_CS. As shown, the data control signal D_CS is supplied from the timing controller 50.

The power supply 40 may generate the gate-on voltage VON, the gate-off voltage VOFF, an analog driving voltage AVDD and an input voltage VIN, from an external driving voltage. The gate-on and gate-off voltages VON and VOFF are supplied to the gate driver 20, the analog driving voltage AVDD is supplied to the data driver 30, and the input voltage VIN is supplied to the backlight driver 70.

The timing controller 50 receives the data signals R, G and B from an external device and supplies them to the data driver 30. The timing controller 50 generates the gate control signal G_CS and the data control signal D_CS. The timing controller 50 supplies the gate control signal G_CS to the gate driver 20 and data control signal D_CS to the data lines 30.

The backlight unit 80 includes a plurality of the light-emitting regions. Respective light-emitting regions may include at least one light-emitting diode (“LED”).

The backlight driver 70 supplies an LED driving voltage VLED to the respective light-emitting regions to drive the LED. The backlight driver 70 controls the current level in response to a dimming signal DS applied from the luminance control signal generator 60 to supply the current to the light-emitting regions.

The luminance control signal generator 60 generates the dimming signal DS based on the pixel data signals R, G and B input from the external device. The luminance control signal generator 60 generates a compensation value by calculating the amount of light interference that happens along the periphery of the light-emitting region in advance. The luminance control signal generator 60 generates the dimming signal DS corresponding to the compensation value to supply the dimming signal DS to the backlight driver 70.

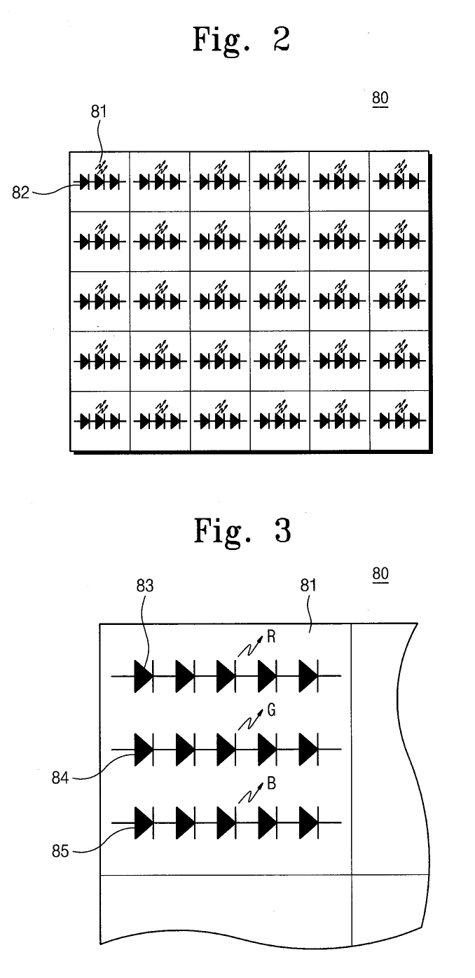

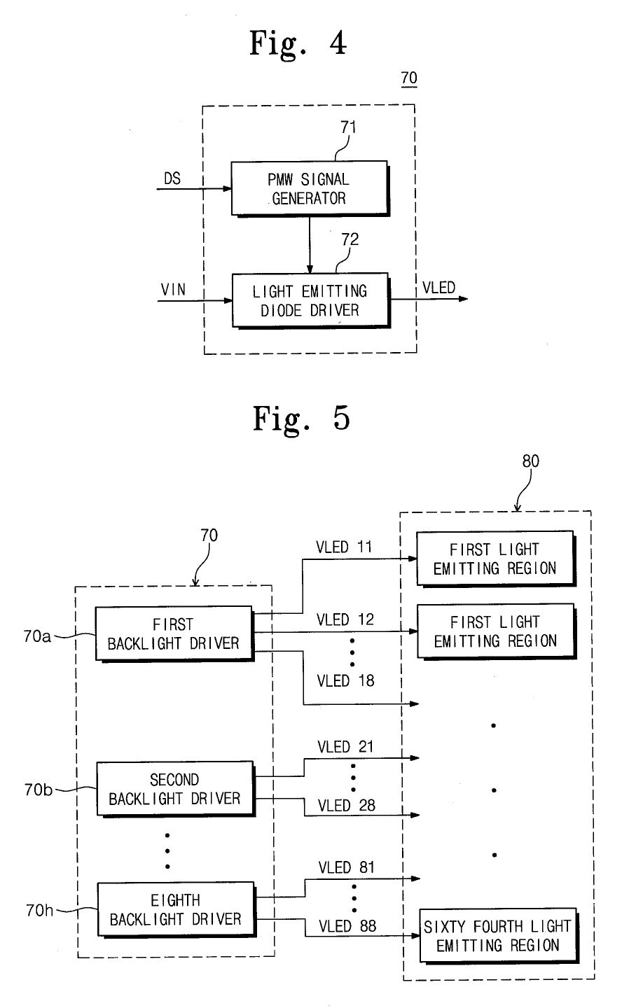

FIG. 2 is a plan view schematically illustrating the backlight unit in FIG. 1 according to a second embodiment of the present invention, and FIG. 3 is a plan view schematically illustrating the backlight unit of FIG. 1 according to a third embodiment of the present invention. Referring to FIG. 2, the backlight unit 80 includes light-emitting regions 81 having at least one LED 82.

The LED 82 formed in the light-emitting regions 81 may include a plurality of white LEDs generating white light, and the white LEDs may be electrically connected to each other in series.

Referring to FIG. 3, the light-emitting regions 81 may include red, green and blue LEDs 83, 84 and 85 to generate white light. When the red, green and blue LEDs 83, 84 and 85 are formed in the respective light-emitting regions 81, each of the LEDs 83, 84 and 85 is electrically connected to each other in series, grouped according to color (e.g., same color LEDs are connected in series). The backlight driver 70 may be formed for driving the LEDs 83, 84 and 85 in color groups, each color group having LEDs of the same color.

FIG. 4 is a schematic block diagram illustrating the backlight driver in FIG. 1, and FIG. 5 is a schematic block diagram of the relationship between a backlight driver and the backlight unit in FIG. 1. Herein, the backlight driver will be described with an embodiment having white LEDs electrically connected to each other in series.

As illustrated in FIG. 4, the backlight driver 70 may include a pulse width modulation (“PWM”) signal generator 71 and an LED driver 72 to supply current to the LED formed in the light-emitting region.

The PWM signal generator 71 may generate a PWM signal with a duty ratio for generating the dimming signal DS. The PWM signal may be used in dimness control since the PWM signal may control the current as a function of a time. Alternatively, a signal generator functioning as the PWM signal generator 71 may be used in the LCD device. For example, the PWM signal generator 71 may perform a dimness control by controlling a voltage level to be supplied to the light-emitting regions by an intensity modulation method which modulates voltage intensity according to the dimming signal DS.

The LED driver 72 receives the input voltage VIN from the power supply 40 and the PWM signal from the PWM signal generator 71 to generate the LED driving voltage VLED. The LED driver 72 converts the PMW signal with the duty ratio into direct voltage to supply the LED driving voltage to the LED.

The backlight driver 70 may be formed as a single chip or multiple chips. If formed as multiple chips, signals may be exchanged between chips.

The number of the backlight drivers 70 may be substantially equal to the number of the light-emitting regions. In some embodiments, a single backlight driver 70 may drive a plurality of the light-emitting regions.

As shown in FIG. 5, first to eighth backlight drivers 70a to 70h may supply the LED driving voltages VLED 11 to VLED 18, VLED 21 to VLED 28 . . . , and VLED 81 to VLED 88 to the LEDs formed in first to sixty-fourth light-emitting regions of the backlight unit 80, respectively. The first backlight driver 70a may supply the first to eighth LED driving voltages VLED 11 to VLED 18 to the LEDs formed in the first to eighth light-emitting regions, respectively. The second backlight driver 70b may supply the ninth to sixteenth LED driving voltages VLED 21 to VLED 28 to the LEDs formed in the ninth to sixteenth light-emitting regions, respectively. Accordingly, the LED driving voltages VLED 11 to VLED 18, VLED 21 to VLED 28 . . . , and VLED 81 to VLED 88 are supplied to the LEDs formed in 64 light-emitting regions through the first to eighth backlight drivers 70a to 70h.

When a single backlight driver supplies driving voltages to the plurality of the light-emitting regions, the manufacturing cost is reduced by reducing the number of backlight drivers.

The light-emitting regions may include red, green and blue LEDs. When the red, green and blue LEDs are formed in the respective light-emitting regions, red, green and blue backlight drivers are formed in the LCD device to drive the red, green and blue LEDs by supplying the LEDs with driving voltages. The red LEDs, green LEDs, and blue LEDs are formed separately and the same colored LEDs may be electrically connected in series.

In FIG. 5, a single backlight driver supplies the LEDs in the eight light-emitting regions with driving voltages. However, this is not a limitation of the invention, and the number of the backlight drivers may be determined by the number of the light-emitting regions. Also, the number of backlight drivers may be determined by the number of LEDs formed in each of the light-emitting regions.

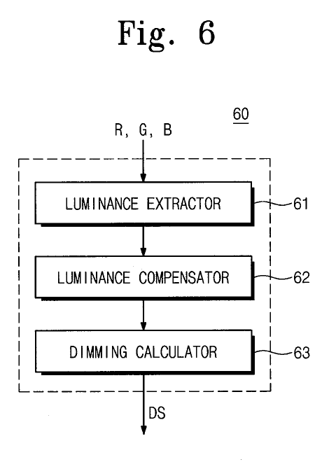

FIG. 6 is a schematic block diagram of the luminance control signal generator of the LCD device.

Referring to FIG. 6, the luminance control signal generator 60 may include a luminance extractor 61, a luminance compensator 62, and a dimming calculator 63.

The luminance extractor 61 receives the pixel data signals R, G, and B from an external device and temporarily stores the signals R, G, and B. The luminance extractor 61 allots the stored pixel data signals R, G, and B to the display region corresponding to the light-emitting region. The luminance extractor 61 extracts luminance information for the respective display regions by data converting the pixel data signals R, G, and B and calculates the corresponding luminance values of the respective display regions. A luminance value may be an average value, a maximum value or a minimum value relating to the luminance information of the respective display region.

The luminance compensator 62 generates a compensation value by using a filter window. The compensation value is calculated by adding the corresponding luminance value to an interference value. The interference value is a luminance value that indicates the amount of interference between light that is emitted from the light-emitting region of a the display region and light from an adjacent region. The compensation value is the sum of the corresponding luminance value and the interference value.

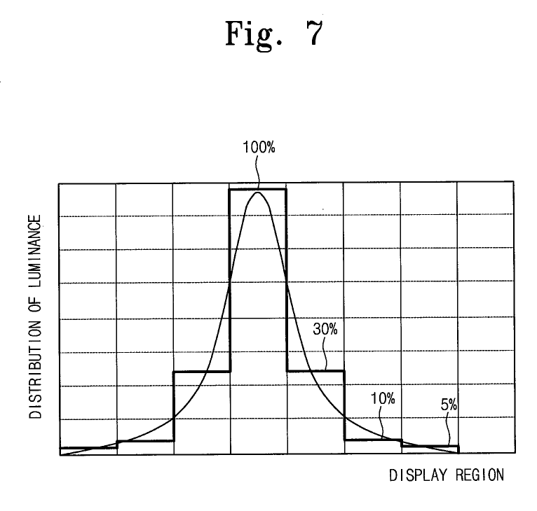

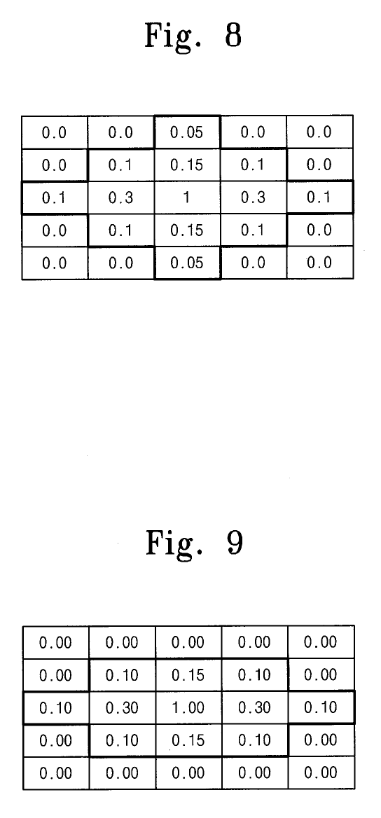

For example, as shown in FIG. 7, the light emitted from a light-emitting region has a luminance distribution of a Gaussian shape. The light emitted from the light-emitting region interferes with light from an adjacent display region. The interfering light amount may be computed by using a point spread function (“PSF”). For example, about 5% to about 30% of the light emitted from the light-emitting region may interfere with light from an adjacent display region. The compensation value is computed by applying a filter window using the PSF in reverse.

FIG. 8 is a block diagram of a 5×5 point spread function (“PSF”) filter window, and FIG. 9 is a block diagram of a 3×5 PSF filter window.

As shown in FIG. 8, a center display region has a luminance value of 1, and two display regions positioned to the left and right of the center display region have a luminance value of 0.3. Two display regions positioned above and below the center display region have a luminance value of 0.15, and four display regions positioned at the corners of the center display region have a luminance value of 0.1. Two display regions positioned next to the left and right display regions have a luminance value of 0.1, and two display regions positioned next to the display regions that are above and below the center display region have a luminance value of 0.06. Luminance values of display regions other than the center display region are approximated by using interference with the light emitted from the center light-emitting region.

As shown in FIG. 9, the 3×5 PSF filter window may be used. If needed, the PSF filter window may be changed according to the number of display regions, the maximum luminance value of the light-emitting region, and the luminance distribution.

Using the PSF filter window, the light emitted from the light-emitting region has a greater luminance value than the display region so that the LCD device may prevent display of a spot or a flash phenomenon caused by a luminance difference between a center display region and an adjacent display region. The luminance compensator 62 obtains the compensation value for the corresponding luminance value by applying the corresponding luminance value of the display region to the PSF filter window.

In FIG. 8 and FIG. 9, the maximum interference value is limited to 0.3 through the filter window. The interference value may vary according to the number of light-emitting regions, the number and distribution of light-emitting diodes, and the maximum luminance value of the light-emitting diodes.

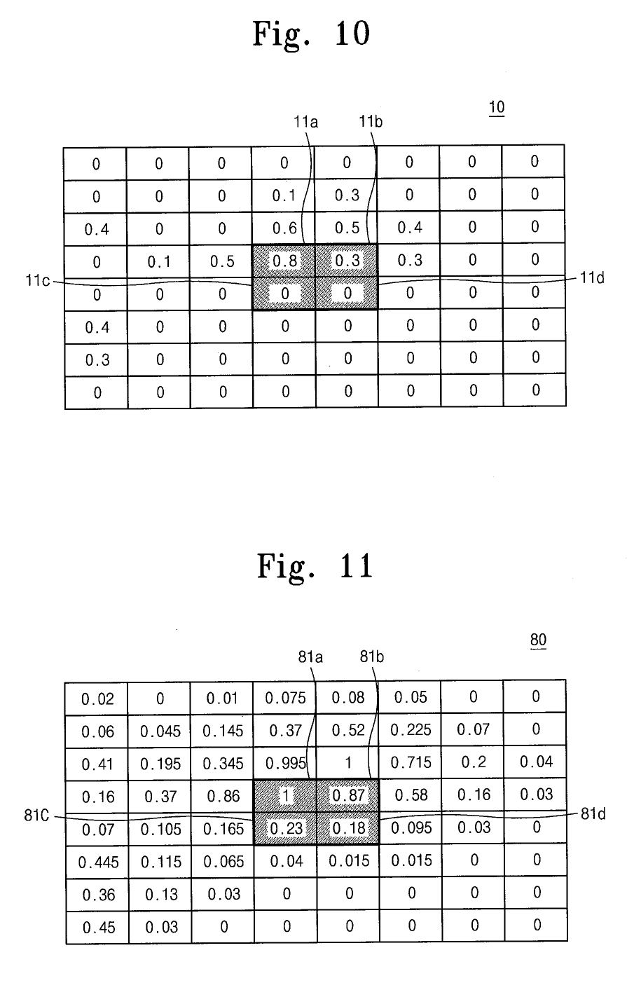

FIG. 10 is a block diagram illustrating the luminance values of display regions in an LCD panel, and FIG. 11 is a block diagram illustrating predetermined luminance values of a respective light-emitting region that a luminance compensator obtained by using a compensation value. FIG. 11 illustrates the luminance values obtained by applying 5×5 PSF filter window in the luminance compensator in FIG. 6.

Referring to FIGS. 10 and 11, the LCD panel 10 includes 64 display regions corresponding to 64 light-emitting regions when the backlight unit includes 64 light-emitting regions. Each of the display regions has a corresponding luminance value. As shown in FIG. 10, four display regions 11a, 11b, 11c and 11d partitioned by a thick solid line has luminance values of 1, 0.3, 0 and 0, respectively. The display region 11a having a luminance value of 1 represents 100% luminance, and the display region 11b having a luminance value of 0.3 represents 30% luminance. The display regions 11c and 11d having a luminance value of 0 represent 0% luminance, which indicates that black color is displayed. Each of other remaining display regions also may have a corresponding luminance value.

When the LCD panel 10 having the corresponding luminance value for the display regions is applied in the 5×5 PSF filter window, the compensation value corresponding to the light-emitting regions is computed to emit light corresponding to the compensation value.

Four light-emitting regions 81a, 81b, 81c and 81d corresponding to the four display regions 11a, 11b, 11c and 11d, partitioned by the thick solid line in FIG. 10, emit light having the predetermined luminance values 1, 0.87, 0.23, and 0.18 corresponding to the compensation values. The light-emitting region 81a having the predetermined luminance value 1 supplies a maximum luminance value of an LED formed in the light-emitting region 81a to the display region 11a corresponding to the light-emitting region 81a regardless of the amount of interfering luminance. The light-emitting region 81b having the predetermined luminance value 0.87 supplies a higher compensation value than the luminance value of 0.3 to the display region 11b corresponding to the light-emitting region 81b. While the display region 11b has a luminance value of 0.3, the predetermined luminance value of the light-emitting region 81b is the sum of the interfered luminance amount with the adjacent light-emitting regions. That is, the light-emitting region 81b supplies the predetermined luminance value of 0.87, which is higher than the luminance value of 0.3, to the display region 11b, thereby preventing the display of a spot caused by a luminance difference between the display region 11b and the adjacent display region 11a having a luminance value of 1.

The light-emitting region 81c supplies the predetermined luminance value of 0.23 to the display region 11c, and the light-emitting region 81c is positioned below the light-emitting region 81a having the predetermined luminance value of 1. While the display region 11c has a luminance value of 0, the predetermined luminance value 0.23 is supplied to the display region 11c in consideration of the amount of interfering light, thereby preventing the display of a spot that is caused by the luminance difference between a display region and the adjacent display region.

The luminance compensator 62 computes the compensation value and supplies the value to the dimming calculator 63.

The dimming calculator 63 generates dimming signals DS corresponding to the respective light-emitting regions by using the compensation value. For example, when the display region displays white color, the light-emitting region corresponding to the display region generates light having a maximum luminance. Accordingly, the dimming calculator 63 supplies 100% dimming signal DS to the backlight driver 70 corresponding to the display region that displays white color. Each of other remaining display regions receives the dimming signals DS corresponding to its compensation value.

The dimming signal DS calculated from the dimming calculator 63 is supplied to the backlight driver 70. The dimming signal DS supplied to the backlight driver 70 controls the duty ratio of a PWM signal to drive the LEDs formed in the light-emitting regions.

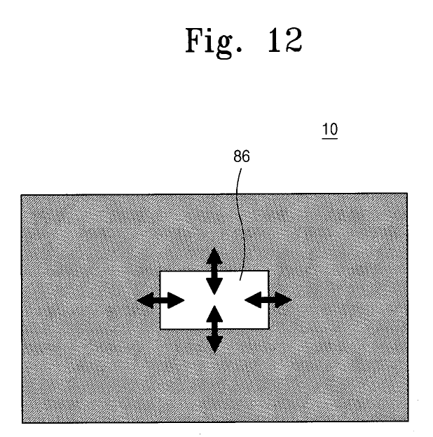

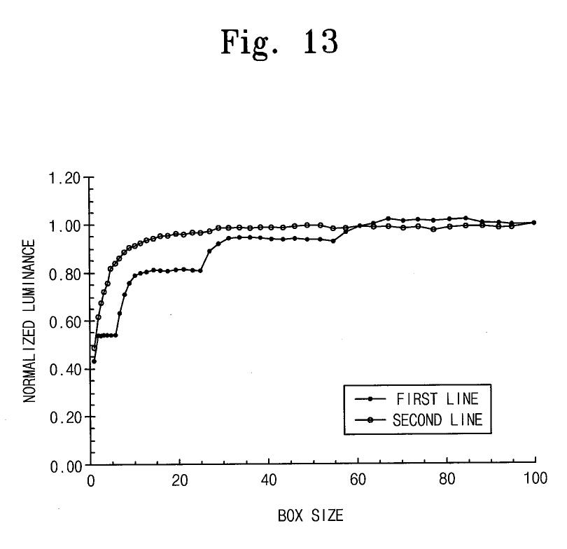

FIG. 12 is a plan view illustrating the effectiveness of the luminance control signal generator in the LCD device according to the first embodiment of the present invention, and FIG. 13 is a graph representing luminance values of a respective display region obtained in FIG. 12.

FIG. 13 is the graph representing normalized luminance being measured according to a size of a test block 86 and according to the driving state of the luminance control signal generator 60. The abscissa represents an increase in ratio in proportion to an initial size of the test block 86 and the ordinate represents the normalized luminance being measured in the test block 86.

The test block 86 of the LCD panel 10 is set up in a predetermined size, and the size increases during the test. The maximum gray scale test block 86 is formed on the minimum display region. As the size of the test block 86 increases, the luminance of the center of the test block 86 is measured.

When the luminance control signal generator 60 in FIG. 1 is not operated, the normalized luminance as shown in a first line in FIG. 13 sharply increases at the regions corresponding to 10%, 30%, and 60% of the test block 86. The display device generates undesirable artifacts, such as flashing, at these regions of sharp luminance increase. However, when the luminance control signal generator 60 in FIG. 1 is operated, the normalized luminance does not show these regions of sharp increase, as shown in a second line in FIG. 13. Rather, the normalized luminance continuously increases, rapidly at first and then gradually. In this case, the display device does not generate undesirable artifacts such as flashing.

Accordingly, in the LCD device in accordance with an embodiment of the present invention, the luminance control signal generator controls the luminance of each of the light-emitting regions to prevent formation of undesirable artifacts such as flashing. The luminance control signal generator achieves this by reducing the luminance difference between the light-emitting regions.

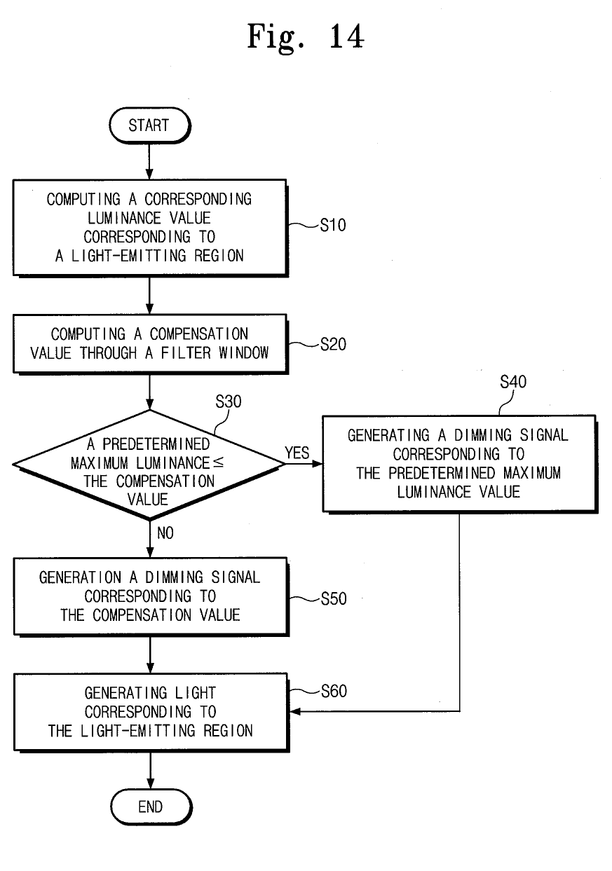

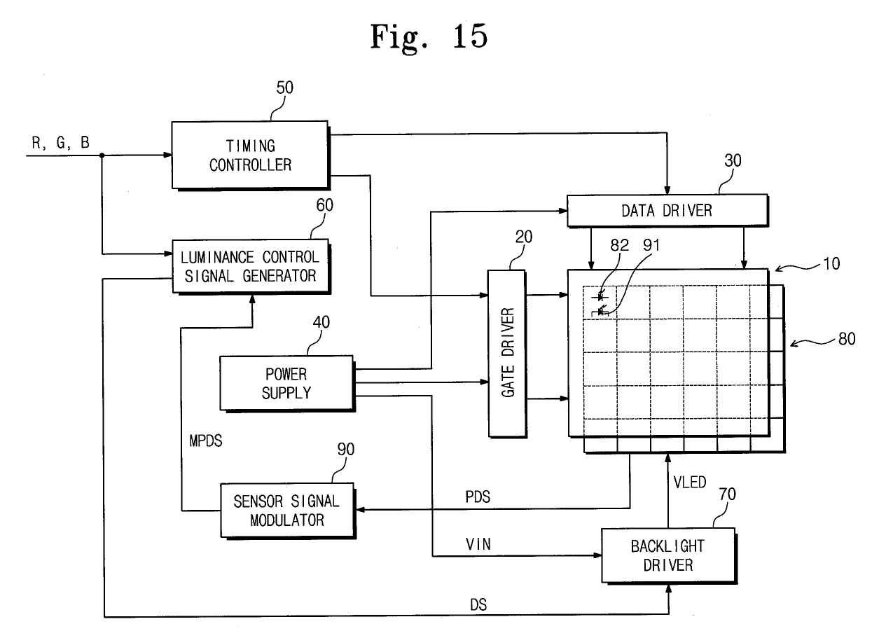

FIG. 14 is a flow chart of a method of driving the LCD device according to an embodiment of the present invention.

Referring to FIG. 14, the method of driving the LCD device includes computing a corresponding luminance value corresponding to each of light-emitting regions (step S10), computing a compensation value through a filter window (step S20), comparing the compensation value with a predetermined maximum luminance value (step S30), generating a dimming signal corresponding to the predetermined maximum luminance value (step S40), generating a dimming signal corresponding to the compensation value (step S50), and generating light corresponding to each of light-emitting regions (step S60).

The corresponding luminance value corresponding to each light-emitting regions is computed by allotting data signals input from an external device to each display regions in step S10. The corresponding luminance value may be a fixed value, a sum or an average value of luminance information of the data signals.

The compensation value is computed by using the filter window, such as the PSF filter window in step S20. The PSF filter window includes 5×5 point spread PSF filter window, 3×5 PSF filter or Gaussian filter window.

The compensation value is value that adds the corresponding luminance value to the interference value through the filter window.

In step 30, the predetermined maximum luminance value is fixed as the current level that is required to produce maximum luminance by the backlight unit. The predetermined maximum luminance is compared to the compensation value. Since the plurality of the LEDs formed in the backlight unit may be damaged by receiving a current of a level that is higher than the maximum allowed current level, the predetermined maximum luminance value may be set up at about 80% to about 100% of the maximum current level.

In step S40, when the compensation value is equal to or more than the predetermined maximum luminance value, a dimming signal corresponding to the predetermined maximum luminance value is generated. The dimming signal has 100% duty ratio of the PWM signal.

In the step S50, when the compensation value is less than the predetermined maximum luminance value, the dimming signal corresponding to the compensation value is generated. The dimming signal has less than 100% duty ratio of the PWM signal.

In the step S60, the duty ratio of the PMW signal is controlled by the dimming signal corresponding to the predetermined maximum luminance value or the dimming signal corresponding to the compensation value. The LED driving voltage is applied to each of the light-emitting regions by the controlled duty ratio. When the dimming signal corresponding to the compensation value is applied, the PWM signal has a duty ratio that is between about 0% and about 100%. When the dimming signal corresponding to the predetermined maximum luminance value is applied, the PWM signal has 100% duty ratio.

The duty ratio of the PWM signal is controlled by the applied dimming signal to adjust the luminance of the LEDs formed in each of the light-emitting regions.

FIG. 15 is a schematic block diagram of an LCD device according to a second embodiment of the present invention.

The LCD device in accordance with the second embodiment includes an LCD panel 10, a gate driver 20, a data driver 30, a timing controller 50, a backlight unit 80, a backlight driver 70, a luminance control signal generator 60, a light sensor 91, and sensor signal modulator 90.

The LCD panel 10, the gate driver 20, the data driver 30, and the timing controller 50 in FIG. 15 have the same configuration as the components that are assigned the same reference numerals in FIG. 1, and their detailed description will not be repeated.

The backlight unit 80 includes LEDs 82 formed in each of light-emitting regions 81 and the light sensor 91 detecting the light amount from the LEDs 82.

The light sensor 91 is formed at a predetermined location of the each of the light-emitting regions 81 to detect the luminance level of the LEDs 82 and to supply an analog or a digital light detect signal PDS to the sensor signal modulator 90.

The sensor signal modulator 90 modulates the light detect signal PDS input from the light sensor 91 to supply a modulate signal MPDS to the luminance control signal generator 60 as a feedback. The modulate signal MPDS modulates signals to match the signal-type of the data pixel signals R, G, and B, which are fed from an external device to the luminance control signal generator 60. For example, when the data pixel signals R, G, and B that are input to the luminance control signal generator 60 use a low voltage differential signaling (“LVDS”), the sensor signal modulator 90 modulates the light detect signal PDS into LVDS.

The sensor signal modulator 90 may modulate the light detect signal PDS so as to supply the light detect signal PDS to each of the light-emitting regions 81. The sensor signal modulator 90 may supply the modulated light detect signal PDS, which includes information for distinguishing the light-emitting regions 81 from one another, to the luminance control generator 60.

The compensation value may be controlled in real time by judging whether the light according to the compensation value is supplied to the LCD panel 10 at the LED 82.

The sensor signal modulator 90 may be formed as an additional chip or may be formed in the backlight driver 70.

Accordingly, the display device and driving method according to the present invention may improve the contrast ratio of images by controlling the luminance of each of the light-emitting regions. Also, this present invention may prevent the display spot between the display region and the adjacent display region by providing light to the adjacent display region having a luminance different from the display region. The display device according to the present invention may improve the overall luminance of the display device and may reduce power consumption by supplying individual signals to each of the light-emitting regions. A conventional backlight unit does not allow such individualized control of the light-emitting regions.

It will be apparent to those skilled in the art, in light of the above, that various modifications and variations can be made without departing from the spirit or scope of the disclosure. Thus, it is intended that the present disclosure covers the apparent modifications and variations that come within the scope of the disclosed embodiments and their equivalents.

What is claimed is:

1. A display device comprising:
a backlight unit including a plurality of light-emitting regions including a first light emitting region and a second light emitting region that is adjacent to the first light-emitting region;
a display panel displaying images by using light emitted from the backlight unit;
a backlight driver driving the backlight unit; and
a luminance control signal generator controlling a luminance of the first light-emitting region according to an amount of light interference between the first light-emitting region and the second light-emitting region.

2. The display device of claim 1, wherein the luminance control signal generator comprises:
a luminance extractor to generate a luminance value of each of the light-emitting regions in response to pixel data signals;
a luminance compensator to compute an interference value corresponding to the luminance value and to generate a compensation value, wherein the interference value indicates the amount of light interference; and
a dimming calculator to generate a dimming signal corresponding to the compensation value and to supply the dimming signal to the backlight driver.

3. The display device of claim 2, wherein the interference value is between about 5% and about 30% of the luminance value.

4. The display device of claim 2, wherein the luminance control signal generator compares the compensation value with a predetermined maximum luminance value corresponding to a maximum current level that is allowed for each of the light-emitting regions, generates the dimming signal corresponding to the compensation value when the compensation value is less than the maximum luminance value, and generates the dimming signal corresponding to the predetermined maximum luminance value when the compensation value is equal to or greater than the predetermined maximum luminance value.

5. The display device of claim 4, wherein the backlight driver further comprises:
a pulse width modulation (“PWM”) signal generator to generate PWM signals having a duty ratio corresponding to the dimming signal; and
a light-emitting diode (“LED”) driver to control an electric current according to the duty ratio of the PMW signals.

6. The display device of claim 5, wherein there are a plurality of backlight drivers including the backlight driver, wherein the number of the backlight drivers is equal to the number of the light-emitting regions.

7. The display device of claim 1, wherein the backlight unit comprises at least one LED in each of the light-emitting regions.

8. The display device of claim 7, wherein the backlight unit further comprises a plurality of LEDs electrically connected to each other in series in each of the light-emitting regions.

9. The display device of claim 7, wherein the LED comprises a white LED.

10. The display device of claim 7, wherein the backlight unit further comprises a red LED, a green LED, and a blue LED in each of the light-emitting regions.

11. The display device of claim 10, wherein the backlight unit comprises a plurality of red LEDs, a plurality of green LEDs, and a plurality of blue LEDs electrically connected in series to the same color LEDs, and
the backlight driver drives the red LED, the green LED, and the blue LED in color groups, each color group having LEDs of the same color.

12. The display device of claim 1, further comprising:
a light sensor to measure a luminance of the backlight unit; and
a sensor signal modulator to modulate a light detect signal provided from the light sensor and to supply the light detect signal to the luminance control signal generator.

13. A method of driving a display device comprising:
computing a luminance value of each of light-emitting regions in a backlight unit;
computing a compensation value for each of the light-emitting regions;
generating a dimming control signal corresponding to the compensation value; and
supplying light corresponding to the dimming signal to each of the light-emitting regions.

14. The method of claim 13, wherein the computing of the compensation value further comprises adding the luminance value to an interference value, wherein the interference value indicates an amount of interference between light from adjacent display regions.

15. The method of claim 14, wherein the generating of the dimming signals further comprises:
comparing the compensation value with a predetermined maximum luminance value;
generating the dimming signal corresponding to the predetermined maximum luminance value when the compensation value is equal to or greater than the predetermined maximum luminance value; and
generating the dimming signal corresponding to the compensation value when the compensation value is less than the predetermined maximum luminance value.

16. The method of claim 15, wherein the generating of light comprises:
generating a PWM signal having a duty ratio corresponding to the dimming signal; and
supplying an electric current corresponding to the duty ratio to each of the light-emitting regions.

17. The method of claim 16, wherein the supplying the electric current comprises:
measuring a luminance corresponding to each of the light-emitting regions; and
comparing the measured luminance with the compensation value to control the luminance of the backlight unit.
